(19) United States
(12) Patent Application Publication
(10) Pub. No.: US 2020/0334555 A1
(43) Pub. Date: Oct. 22, 2020

(54) ARTIFICIAL NEURAL NETWORK REGULARIZATION SYSTEM FOR A RECOGNITION DEVICE AND A MULTI-STAGE TRAINING METHOD ADAPTABLE THERETO

(71) Applicants: NCKU Research and Development Foundation, Tainan City (TW); Himax Technologies Limited, Tainan City (TW)

(72) Inventors: Tzu-Shiuan Liu, Tainan City (TW); Ming-Der Shieh, Tainan City (TW)

(21) Appl. No.: 16/386,784

(22) Filed: Apr. 17, 2019

(51) Int. Cl. G06N 5/04; G06N 3/08; G06N 3/04; G06N 20/20

(52) U.S. Cl. CPC G06N 5/046; G06N 20/20; G06N 3/0454; G06N 3/08

(57) ABSTRACT

An artificial neural network regularization system for a recognition device includes an input layer generating an initial feature map of an image; a plurality of hidden layers convoluting the initial feature map to generate an object feature map; and a matching unit receiving the object feature map and performing matching accordingly to output a recognition result. A first inference block and a second inference block are disposed in at least one hidden layer of an artificial neural network. The first inference block is turned on and the second inference block is turned off in first mode, in which the first inference block receives only output of preceding-layer first inference block. The first inference block and the second inference block are turned on in second mode, in which the second inference block receives output of preceding-layer second inference block and output of preceding-layer first inference block.

### BACKGROUND OF THE INVENTION

### 1. Field of the Invention

The present invention generally relates to machine learning, and more particularly to a convolutional neural network (CNN) regularization system or architecture for object recognition.

### 2. Description of Related Art

A convolutional neural network (CNN) is one of deep neural network that uses convolutional layers to filter inputs for useful information. The filters in the convolutional layers may be modified based on learned parameters to extract the most useful information for a specific task. The CNN may commonly be adaptable to classification, detection and recognition such as image classification, medical image analysis and image/video recognition. CNN inference, however, requires significant amount of memory and computation. Generally speaking, the higher accuracy the CNN model has, the more complex architecture (i.e., more memory and computation) and higher power consumption the CNN model requires.

As low-power end devices such as always-on-sensors (AOSs) grow, demand of low-complexity CNN is increasing. However, the low-complexity CNN cannot attain performance as high as high-complexity CNN due to limited power. The AOSs under power-efficient co-processors with low-complexity CNN would continuously detect simple objects until main processors with high-complexity CNN are activated. Accordingly, two CNN models (i.e., low-complexity model and high-complexity model) need be stored in system, which, however, requires more static random-access memory (SRAM) devices that are expensive in cost.

### SUMMARY OF THE INVENTION

In view of the foregoing, it is an object of the embodiment of the present invention to provide a convolutional neural network (CNN) regularization system that can support multiple modes for substantially reducing power consumption.

According to one embodiment, a multi-stage training method adaptable to an artificial neural network regularization system, which includes a first inference block and a second inference block disposed in at least one hidden layer of an artificial neural network, is proposed. A whole of the artificial neural network is trained to generate a pre-trained model. Weights of first filters of the first inference block are fine-tuned while weights of second filters of the second inference block are set zero, thereby generating a first model. Weights of the second filters of the second inference block are fine-tuned but weights of the first filters of the first inference block for the first model are fixed, thereby generating a second model.

### BRIEF DESCRIPTION OF THE DRAWINGS

FIG. 1 shows a schematic diagram exemplifying a convolutional neural network (CNN) regularization system for a recognition device according to one embodiment of the present invention;

FIG. 2 shows a flow diagram illustrating a multi-stage training method adaptable to the CNN regularization system of FIG. 1 according to one embodiment of the present invention;

FIG. 3 shows another schematic diagram exemplifying a convolutional neural network (CNN) regularization system for a recognition device according to one embodiment of the present invention; and

FIG. 4 shows a schematic diagram exemplifying a convolutional neural network (CNN) regularization system for a recognition device according to another embodiment of the present invention.

### DETAILED DESCRIPTION OF THE INVENTION

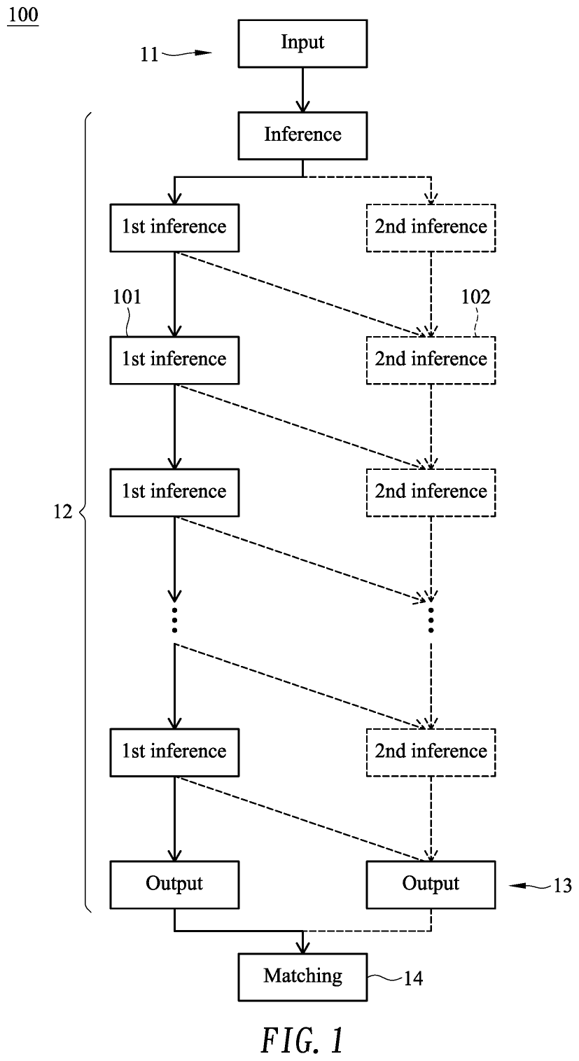

FIG. 1 shows a schematic diagram exemplifying a convolutional neural network (CNN) regularization system 100 for a recognition device according to one embodiment of the present invention. The CNN regularization system 100 may be implemented, for example, by a digital image processor with memory devices such as static random-access memory (SRAM) devices. The CNN regularization system 100 may be adaptable, for example, to face recognition.

Although CNN is exemplified in the embodiment, it is appreciated that the embodiment may be generalized to an artificial neural network that is an interconnected group of nodes, similar to the vast network of neurons in a brain. According to one aspect of the embodiment, the CNN regularization system 100 may support multiple (operating) modes, one of which may be selectably operable at. Specifically, the CNN regularization system 100 of the embodiment may be operable at either high-precision mode or low-power mode. The CNN regularization system 100 at low-power mode consumes less power, but obtains lower precision, than at high-precision mode.

In the embodiment, as shown in FIG. 1, the CNN regularization system 100 may be composed of an input layer 11, a plurality of hidden layers 12 (including an output layer 13 that outputs an object feature map (or object feature or object vector)). Specifically, the input layer 11 may generate an initial feature map of an image. The hidden layers 12 may convolve the initial feature map to generate the object feature map. Within at least one hidden layer 12, the CNN regularization system 100 of the embodiment may include a first inference block (or group) 101 (as designated as solid-line block), each containing plural first nodes or filters. Within at least one hidden layer 12, the CNN regularization system 100 of the embodiment may include a second inference block (or group) 102 (as designated as dotted-line block), each containing plural second nodes or filters. As exemplified in FIG. 1, at least one first inference block 101 and at least one second inference block 102 are disposed at a same hidden layer 12.

The CNN regularization system 100 of the embodiment may include a matching unit 14 (e.g., face matching unit) coupled to receive object feature map (e.g., face feature map, face feature or face vector) of the output layer 13, and configured to perform (object) matching in companion with a database to determine, for example, whether a specific object (such as face) has been recognized as a recognition result. Conventional techniques of face matching may be adopted, details of which are thus omitted for brevity.

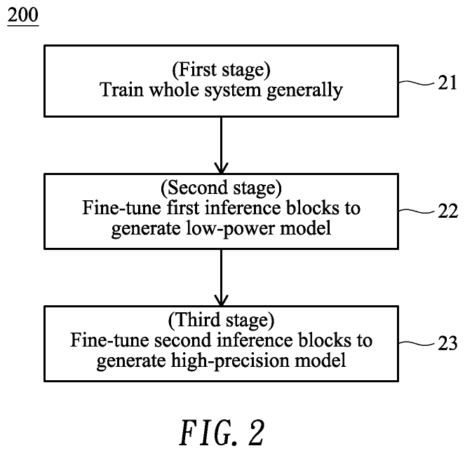

FIG. 2 shows a flow diagram illustrating a multi-stage training method 200 adaptable to the CNN regularization system 100 of FIG. 1 according to one embodiment of the present invention. In the embodiment, the multi-stage training method 200 provides three-stage training. According to another aspect of the embodiment, the multi-stage training method 200 may achieve one (trained) model with multiple operating modes (e.g., high-precision mode and low-power mode).

In first stage (step 21), a whole of the CNN regularization system 100 may be trained as in a general training flow, thereby generating a pre-trained model. That is, the nodes (or filters) of the first inference blocks 101 and the second inference blocks 102 are trained generally in the first stage.

In second stage (step 22), weights of the first nodes of the first inference blocks 101 for the pre-trained model may be fine-tuned and weights of the second nodes of the second inference blocks 102 may be set zero (or turned off), thereby generating a low-power (first) model. As exemplified in FIG. 1, weights of the first nodes of the first inference blocks 101 are fine-tuned along an inference path (as designated as solid lines), while weights of the second nodes of the second inference blocks 102 are set zero. Specifically, in the embodiment, each first inference block 101 may receive only outputs of the first inference block 101 of preceding layer, while each second inference block 102 is turned off.

In third stage (step 23), weights of the second nodes of the second inference blocks 102 may be fine-tuned but weights of the first nodes of the first inference blocks 101 for the low-power model are fixed (as at the end of step 22), thereby generating a high-precision (second) model. As exemplified in FIG. 1, weights of the second nodes of the second inference blocks 102 for the pre-trained model are fine-tuned along an inference path (as designated as dotted lines), while weights of the nodes of the first inference blocks 101 for the low-power model are fixed. In one embodiment, Euclidean length, i.e., L² norm, may be deleted to ensure that model training in third stage could converge and perform properly.

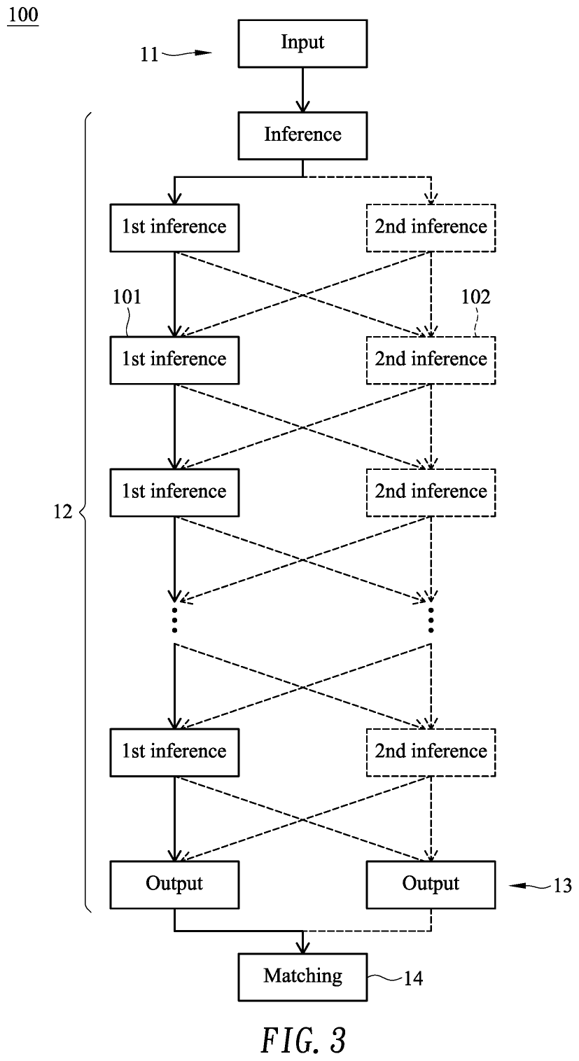

Specifically, in the embodiment, each second inference block 102 may receive outputs of the second inference block 102 of preceding layer, and outputs of the first inference block 101 of preceding layer, while each first inference block 101 may receive only outputs of the first inference block 101 of preceding layer. In another embodiment, as shown in FIG. 3, each first inference block 101 may further receive outputs of the second inference block 102 of preceding layer.

The CNN regularization system 100 as trained according to the multi-stage training method 200 may be utilized, for example, to perform face recognition. The trained CNN regularization system 100 may be operable at low-power mode, in which the second inference blocks 102 may be turned off to reduce power consumption. The trained CNN regularization system 100 may be operable at high-precision mode, in which a whole of the CNN regularization system 100 may operate to achieve high precision.

According to the embodiment disclosed above, as only single system or model is required, instead of two systems or models as in the prior art, the amount of static random-access memory (SRAM) devices implementing a convolutional neural network may be substantially be decreased. Accordingly, always-on-sensors (AOSs) controlled by co-processors would continuously detect simple objects at low-power mode, until main processors are activated at high-precision mode.

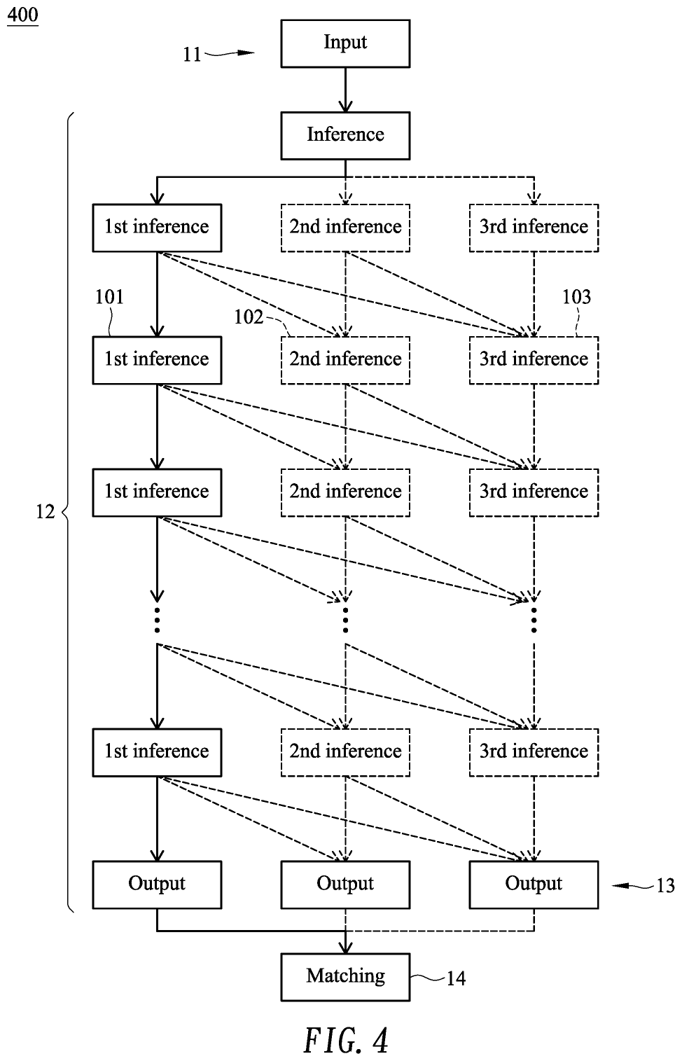

The CNN regularization system 100 as exemplified in FIG. 1/3 may be generalized to a CNN regularization system that may support more than two modes. FIG. 4 shows a schematic diagram exemplifying a convolutional neural network (CNN) regularization system 400 for a recognition device according to another embodiment of the present invention. In the embodiment, within at least one hidden layer 12, the CNN regularization system 400 may further include a third inference block 103.

In first stage of training the CNN regularization system 400, a whole of the CNN regularization system 400 may be trained as in a general training flow, thereby generating a pre-trained model. In second stage, weights of the first nodes of the first inference blocks 101 for the pre-trained model may be fine-tuned and weights of the second nodes of the second inference blocks 102 and the third nodes of the third inference blocks 103 may be set zero (or turned off), thereby generating a first low-power model. In third stage, weights of the second nodes of the second inference blocks 102 may be fine-tuned, the third nodes of the third inference blocks 103 may be set zero, but weights of the first nodes of the first inference blocks 101 for the first low-power model may be fixed, thereby generating a second low-power model. In fourth (final) stage, weights of the third nodes of the third inference blocks 103 may be fine-tuned but weights of the first nodes of the first inference blocks 101 and the second nodes of the second inference blocks 102 for the second low-power model may be fixed, thereby generating a high-precision (third) model.

The trained CNN regularization system 400 may be operable at first low-power mode, in which the second inference blocks 102 and the third inference blocks 103 may be turned off to reduce power consumption. The trained CNN regularization system 400 may be operable at second low-power mode, in which the third inference blocks 103 may be turned off. The trained CNN regularization system 400 may be operable at high-precision mode, in which a whole of the CNN regularization system 400 may operate to achieve high precision.

Although specific embodiments have been illustrated and described, it will be appreciated by those skilled in the art that various modifications may be made without departing from the scope of the present invention, which is intended to be limited solely by the appended claims.

What is claimed is:

1. An artificial neural network regularization system for a recognition device, comprising:
an input layer generating an initial feature map of an image;
a plurality of hidden layers convoluting the initial feature map to generate an object feature map; and
a matching unit receiving the object feature map and performing matching accordingly to output a recognition result;
wherein a first inference block and a second inference block disposed in at least one hidden layer of an artificial neural network, the first inference block containing plural first filters and the second inference block containing plural second filters; and
wherein the first inference block is turned on and the second inference block is turned off in first mode, in which the first inference block receives only output of preceding-layer first inference block; the first inference block and the second inference block are turned on in second mode, in which the second inference block receives output of preceding-layer second inference block and output of preceding-layer first inference block.

2. The system of claim 1, wherein, in the second mode, the first inference block receives only output of preceding-layer first inference block.

3. The system of claim 1, wherein, in the second mode, the first inference block receives output of preceding-layer first inference block and output of preceding-layer second inference block.

4. The system of claim 1, further comprising a third inference block disposed in said at least one hidden layer, the third inference block containing plural third filters.

5. The system of claim 4, wherein the third inference block is turned off in the first mode and the second mode, and is turned on in a third mode.

6. The system of claim 1, wherein the matching unit comprises a face matching unit that determines whether a specific face has been recognized.

7. A multi-stage training method adaptable to an artificial neural network regularization system, which includes a first inference block and a second inference block disposed in at least one hidden layer of an artificial neural network, the method comprising:
training a whole of the artificial neural network to generate a pre-trained model;
fine-tuning weights of first filters of the first inference block while weights of second filters of the second inference block are set zero, thereby generating a first model; and
fine-tuning weights of the second filters of the second inference block but fixing weights of the first filters of the first inference block for the first model, thereby generating a second model.

8. The method of claim 7, wherein, in the step of generating the first model, the first inference block receives only output of preceding-layer first inference block; and in the step of generating the second model, the second inference block receives output of preceding-layer second inference block and output of preceding-layer first inference block.

9. The method of claim 8, wherein, in the step of generating the second model, the first inference block receives only output of preceding-layer first inference block.

10. The method of claim 8, wherein, in the step of generating the second model, the first inference block receives output of preceding-layer first inference block and output of preceding-layer second inference block.

11. The method of claim 7, wherein the artificial neural network further comprises a third inference block disposed in said at least one hidden layer.

12. The method of claim 11, wherein, in the step of generating the first model and the second model, weights of third filters of the third inference block are set zero.

13. The method of claim 12, further comprising:
fine-tuning weights of the third filters of the third inference block but fixing weights of the first filters of the first inference block and weights of the second filters of the second inference block for the second model, thereby generating a third model.

14. The method of claim 7, further comprising:
receiving outputs of an output layer of the artificial neural network and performing matching accordingly.

15. The method of claim 14, wherein the step of performing matching comprises face matching that determines whether a specific face has been recognized.
